(19) United States
(12) Patent Application Publication
(10) Pub. No.: US 2026/0016059 A1
(43) Pub. Date: Jan. 15, 2026

(54) BRAKE ROTOR AND METHOD OF MANUFACTURING THE SAME

(71) Applicant: GM Global Technology Operations LLC, Detroit, MI (US)

(72) Inventors: Yi Liu, Troy, MI (US); Qigui Wang, Rochester Hills, MI (US); Benjamin Everest Slattery, Tecumseh (CA); Heewook Lee, Oakland Township, MI (US)

(73) Assignee: GM Global Technology Operations LLC, Detroit, MI (US)

(21) Appl. No.: 18/772,190

(22) Filed: Jul. 14, 2024

(51) Int. Cl. F16D 65/12; C23C 4/11; C23C 4/134; F16D 65/02

(52) U.S. Cl. CPC F16D 65/128; C23C 4/11; C23C 4/134; F16D 65/125; F16D 2065/132; F16D 2065/1328; F16D 2200/003; F16D 2200/0039; F16D 2250/0046

(57) ABSTRACT

A brake rotor includes a body, at least one thermal barrier, and a substrate. The body includes at least one braking surface and a plurality of venting channels. The at least one thermal barrier is disposed on the at least one braking surface. The at least one thermal barrier includes a first ceramic layer having a first density and a first porosity, and a second ceramic layer having a second density and a second porosity. The second density is less than the first density, and the second porosity is greater than the first porosity. The second ceramic layer is selectively engaged with the at least one braking surface of the body. The substrate is selectively coupled to first ceramic layer of the at least one thermal barrier in a first state of the body. The brake rotor is free of the substrate in a second state of the body.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a brake rotor for a braking system of a vehicle. In many instances, brake rotors are manufactured from cast iron, and depending on the exact size and shape of the brake rotor, its weight may be close to twenty-five (25) pounds due to its cast iron makeup. If the vehicle includes four brake rotors, which is common for vehicles that include four wheels, an additional 100 pounds of weight is added to the vehicle solely from the four brake rotors. While cast iron is a dense material, its use in brake rotors is advantageous, as cast iron is able to withstand high levels of heat that occur at the brake rotor while in use on the vehicle. However, when developing lighter-weight vehicles in efforts to improve fuel economy and/or energy conservation, the twenty-five (25) pound mass of the brake rotor may be less favorable.

As the brake rotor wears, the brake rotor may lose mass, which may cause the brake rotor to heat quicker compared to a new brake rotor that is not yet worn. While other materials aside from cast iron may be used for the brake rotor, the materials may be difficult and time-consuming to manufacture. Furthermore, many materials that are less dense than cast iron may reduce the weight of the brake rotor, but may not be able to withstand the excessive heat experienced at the brake rotor. Accordingly, a need exists for a brake rotor that is not only light-weight, but can also withstand the excessive heat experienced at the brake rotor during operation, resist wearing at the braking surface over an extended period of use, and be manufactured using a simple and efficient process.

### SUMMARY

One aspect of the disclosure provides a brake rotor. The brake rotor includes a body, at least one thermal barrier, and a substrate. The body includes at least one braking surface and a plurality of venting channels. The at least one thermal barrier is disposed on the at least one braking surface. The at least one thermal barrier includes a first ceramic layer having a first density and a first porosity, and a second ceramic layer having a second density and a second porosity. The second density of the second ceramic layer is less than the first density of the first ceramic layer. The second porosity of the second ceramic layer is greater than the first porosity of the first ceramic layer. The second ceramic layer is selectively engaged with the at least one braking surface of the body. The substrate is selectively coupled to first ceramic layer of the at least one thermal barrier in a first state of the body. The brake rotor is free of the substrate in a second state of the body.

Implementations of the disclosure may include one or more of the following optional features. In some examples, the body includes an alloy including at least one of an aluminum-copper alloy and an aluminum-cerium alloy.

In some implementations, the first ceramic layer and the second ceramic layer each include a ceramic material. In some further implementations, the ceramic material includes at least one of magnesium zirconate and yttrium stabilized zirconia.

In some aspects, the body is liquid in the first state and is at least partially disposed within the second ceramic layer of the at least one thermal barrier.

In some configurations, the body is solid in the second state and the at least one braking surface is integrally formed with the second ceramic layer of the at least one thermal barrier.

In some examples, the substrate includes a metallic foil material.

In some implementations, the first ceramic layer of the thermal barrier has a thickness between 100 and 500 microns, and the second ceramic layer of the thermal barrier has a thickness between 100 and 500 microns.

In some aspects, a vehicle includes the brake rotor.

Another aspect of the disclosure provides a method for manufacturing a brake rotor. The method includes i) providing a first substrate and a second substrate, ii) depositing, at each of the first substrate and the second substrate, a first ceramic layer, the first ceramic layer having a first density and a first porosity, iii) depositing, at the first ceramic layer deposited at the first substrate, a second ceramic layer having a second density and a second porosity to define a first thermal barrier, the second density being less than the first density of the first ceramic layer and the second porosity being greater than the first porosity, iv) depositing, at the first ceramic layer deposited at the second substrate, the second ceramic layer having the second density and the second porosity to define a second thermal barrier, v) positioning each of the first substrate, the first thermal barrier, the second substrate, and the second thermal barrier in a mold and defining a cavity, vi) depositing a body into the cavity along each of the first thermal barrier and the second thermal barrier when the body is in a first state, vii) removing the body, the first thermal barrier, the first substrate, the second thermal barrier, and the second substrate from the mold when the body is in a second state, and viii) removing the first substrate from the first thermal barrier and removing the second substrate from the second thermal barrier.

Implementations of this aspect of the disclosure may include one or more of the following optional features. In some examples, the body is liquid in the first state and is at least partially disposed within the first thermal barrier and the second thermal barrier once deposited into the cavity. The body is solid in the second state and is integrally formed with the first thermal barrier and the second thermal barrier.

In some implementations, the body includes an alloy including at least one of an aluminum-copper alloy and an aluminum-cerium alloy.

In some aspects, the first ceramic layer and the second ceramic layer each include a ceramic material. The ceramic material includes at least one of magnesium zirconate and yttrium stabilized zirconia.

In some configurations, a curing process allows the body to transition from the first state to the second state.

In some examples, the first ceramic layer of the first thermal barrier and the second thermal barrier has a thickness between 100 and 500 microns, and the second ceramic layer of the first thermal barrier and the second thermal barrier has a thickness between 100 and 500 microns.

Yet another aspect of the disclosure provides a vehicle. The vehicle includes a brake rotor. The brake rotor includes a body, at least one thermal barrier, and a substrate. The body includes at least one braking surface and a plurality of venting channels. The at least one thermal barrier is disposed on the at least one braking surface. The at least one thermal barrier includes a first ceramic layer having a first density and a first porosity, and a second ceramic layer having a second density and a second porosity. The second density of the second ceramic layer is less than the first density of the first ceramic layer. The second porosity of the second ceramic layer is greater than the first porosity of the first ceramic layer. The second ceramic layer is selectively engaged with the at least one braking surface of the body. The substrate is selectively coupled to first ceramic layer of the at least one thermal barrier in a first state of the body. The brake rotor is free of the substrate in a second state of the body.

Implementations of this aspect of the disclosure may include one or more of the following optional features. In some examples, the body includes an alloy including at least one of an aluminum-copper alloy and an aluminum-cerium alloy.

In some implementations, the first ceramic layer and the second ceramic layer each include a ceramic material. The ceramic material includes at least one of magnesium zirconate and yttrium stabilized zirconia.

In some aspects, the body is liquid in the first state and is at least partially disposed within the second ceramic layer of the at least one thermal barrier. The body is solid in the second state and the at least one braking surface is integrally formed with the second ceramic layer of the at least one thermal barrier.

In some configurations, the first ceramic layer of the at least one thermal barrier has a thickness between 100 and 500 microns, and the second ceramic layer of the at least one thermal barrier has a thickness between 100 and 500 microns.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle including a brake rotor;

FIG. 2 is a cross-sectional view of a brake rotor according to the present disclosure positioned in a mold;

FIG. 3 is an example schematic of a foil substrate;

FIG. 4 is another example schematic of the foil substrate of FIG. 3 including a thermal barrier disposed on the foil substrate;

FIG. 5 is another example schematic of the foil substrate and the thermal barrier of FIG. 4 coupled with a brake rotor;

FIG. 6 is an example diagram of a manufacturing process of a thermal barrier and the foil substrate according to the present disclosure;

FIG. 7 is a top plan view of the thermal barrier disposed on a foil substrate according to the present disclosure; and

FIG. 8 is an exemplary flow diagram of a method of manufacturing a brake rotor according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

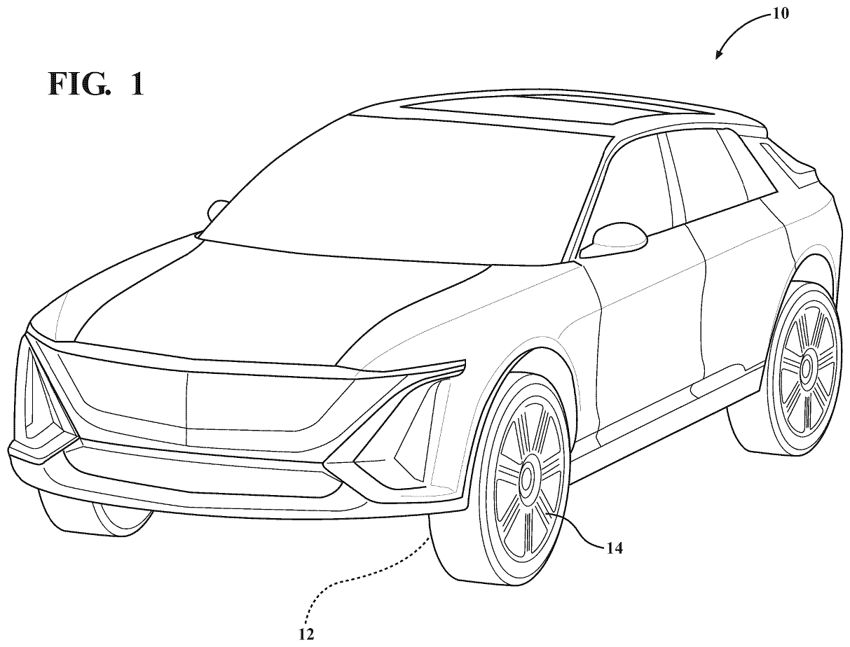

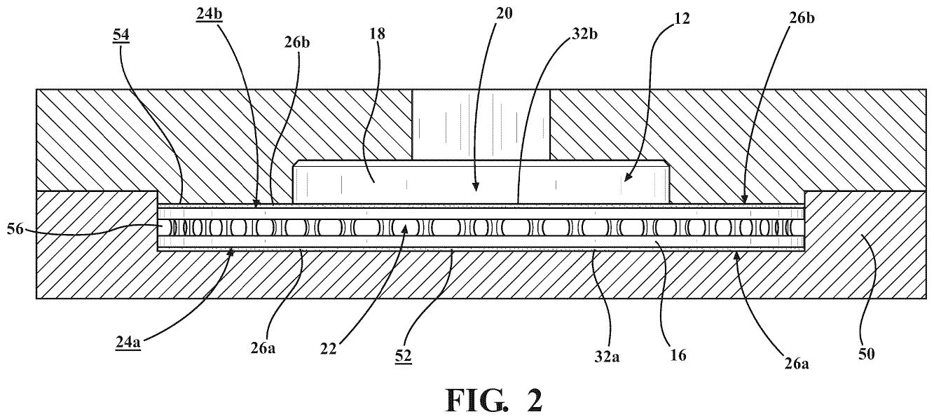

With reference to FIGS. 1 and 2, a vehicle 10 includes at least one brake rotor 12 positioned at or near at least one wheel 14 of the vehicle 10. As the vehicle 10 described herein includes four wheels 14, it can be appreciated that the vehicle 10 may include one brake rotor 12 positioned at or near one wheel 14, or may include four brake rotors 12, each of which is positioned at or near each of the four wheels 14, without diverging from the context of this disclosure. Furthermore, if a vehicle 10 has less than four wheels 14 or more than four wheels 14, the vehicle 10 may include as few as one brake rotor 12 or as many brake rotors 12 as required by the quantity of wheels 14 included with the vehicle 10.

The brake rotor 12 includes a body 16 that comprises an aluminum alloy material. In some examples, the aluminum alloy material may be an aluminum-copper alloy, an aluminum-cerium alloy, or something of the like. For example, the aluminum-copper alloy may include between approximately five (5) percent and approximately ten (10) percent copper, between approximately zero (0) percent and approximately three (3) percent nickel, between approximately 0.3 percent and approximately one (1) percent manganese, and between approximately 0.15 percent and approximately one (1) percent zirconium, with the combination of manganese and zirconium being less than approximately 1.5 percent. In other examples, the aluminum-cerium alloy may include between approximately seven (7) percent and approximately twelve (12) percent cerium, between approximately one (1) percent and approximately five (5) percent nickel, between approximately 0.3 percent and approximately one (1) percent manganese, and between approximately 0.5 percent and approximately 1.5 percent zirconium, with the combination of manganese and zirconium being approximately less than two (2) percent. The aluminum material used for the body 16 of the brake rotor 12 is high strength and highly resistant to heat, which are necessary qualities for the brake rotor 12 for proper operation when installed at the vehicle 10. Specifically, the aluminum alloy material is creep resistant at elevated temperatures above 350 degrees Celsius.

The body 16 includes a hub 18 positioned at a center 20 of the brake rotor 12 and a plurality of venting channels 22 defined within the body 16. The hub 18, when installed at the vehicle 10, interfaces with the wheel 14 of the vehicle 10. Furthermore, the body 16 includes a braking surface 24 that circumscribes the hub 18. The braking surface 24 includes a first braking surface 24a and a second braking surface 24b opposite the first braking surface 24a. When installed at the vehicle 10, both the first braking surface 24a and the second braking surface 24b are at least partially positioned within a brake caliper. The plurality of venting channels 22 are configured to disperse heat during operation of the brake rotor 12, and also reduce a mass of the brake rotor 12.

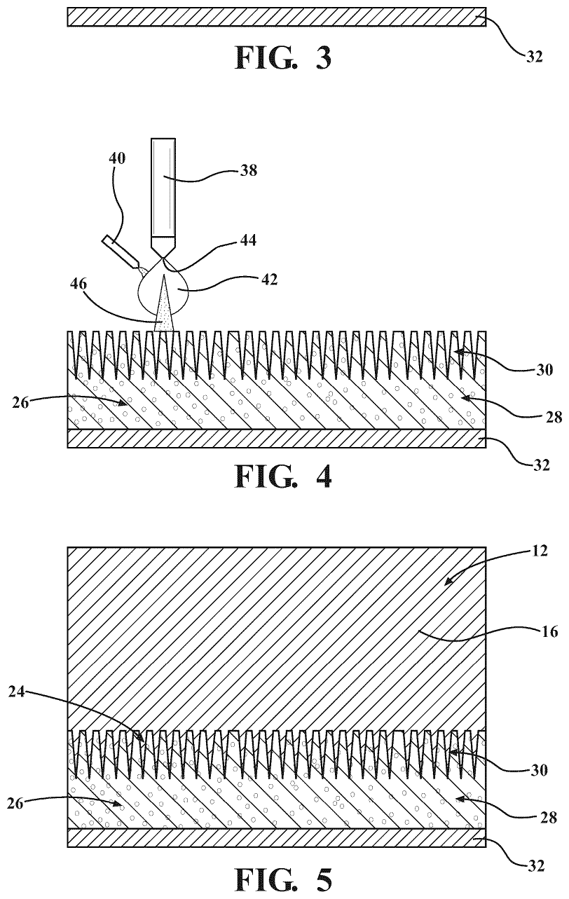

With reference to FIGS. 3-5, a thermal barrier 26 is disposed on the braking surface 24 and is integrally formed with the body 16 of the brake rotor 12. The thermal barrier 26 includes a ceramic material such as magnesium zirconate, 7% yttrium stabilized zirconia, or any practicable ceramic material compound. The ceramic material allows the thermal barrier 26 to have a low thermal conductivity of about 1.45 W/mK at around 1320 degrees Celsius, and a low coefficient of thermal expansion of about 10×10⁻⁶ /K.

A first thermal barrier 26a is disposed on the first braking surface 24a, and a second thermal barrier 26b is disposed on the second braking surface 24b. The thermal barrier 26 includes a first ceramic layer 28 and a second ceramic layer 30, both of which include matching ceramic material. The first ceramic layer 28 has a first density and a first porosity, while the second ceramic layer 30 has a second density and a second porosity. The first density of the first ceramic layer 28 is greater than the second density of the second ceramic layer 30. Likewise, the first porosity of the first ceramic layer 28 is less than the second porosity of the second ceramic layer 30. As the first ceramic layer 28 and the second ceramic layer 30 have matching ceramic materials, the difference in porosity and density between the first ceramic layer 28 and the second ceramic layer 30 are due to a difference in application of the ceramic material, which will be described in greater detail below. The first ceramic layer 28 has a thickness between approximately 100 and 500 microns, while the second ceramic layer 30 also has a thickness between approximately 100 and 500 microns.

The second ceramic layer 30 of the thermal barrier 26 interfaces with the braking surface 24 of the brake rotor 12, while the first ceramic layer 28 interfaces with the second ceramic layer 30. Furthermore, a substrate 32 is included with the brake rotor 12. The substrate 32 may be a metallic foil or metallic foil-like material, such as aluminum foil or any other practicable substrate 32 for building the thermal barrier 26. For example, the substrate 32 may be an application vessel for the thermal barrier 26 during the manufacturing process of the brake rotor 12. Once the manufacturing process of the brake rotor 12 is complete, the substrate 32 is removed and discarded, as the substrate 32 is intended to be sacrificial. The substrate 32 interfaces with the first ceramic layer 28 of the thermal barrier 26, which separates the substrate 32 from the second ceramic layer 30.

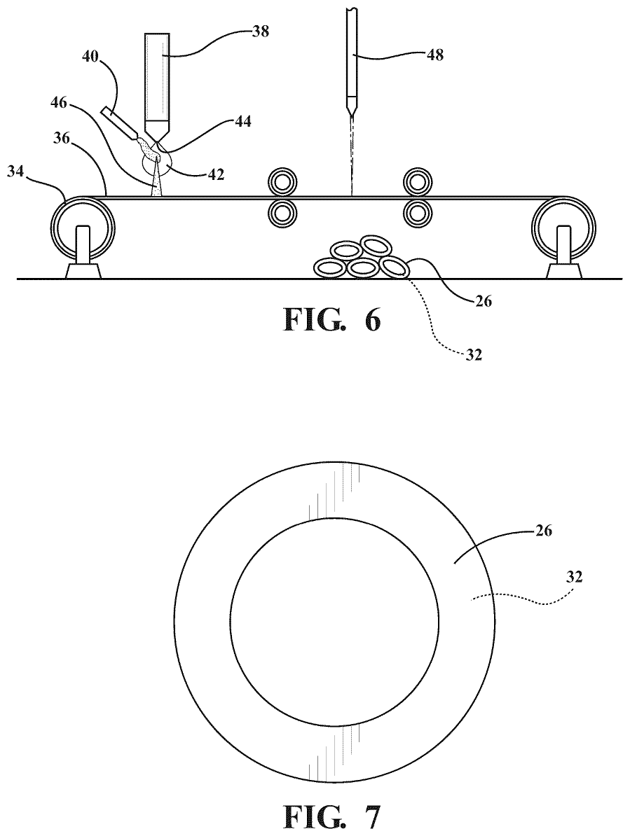

With reference to FIGS. 2-6, the brake rotor 12 may be manufactured using a multi-step method. Initially, the substrate 32 is created to provide a surface on which the thermal barrier 26 may be applied. Although the substrate 32 may be of any material that serves the purpose of an application vessel for the thermal barrier 26, the substrate 32 as set forth in this disclosure comprises an aluminum foil material. For example, an aluminum foil roll 34 may be used to generate an aluminum foil sheet 36 as the aluminum foil sheet 36 is rolled out from the aluminum foil roll 34. An applicator 38 is positioned above the aluminum foil sheet 36. For example, the applicator 38 may be a plasma spray gun. The applicator 38 includes a powder feeder 40 and a plasma field 42 at a distal end 44 of the applicator 38. As the aluminum foil sheet 36 is rolled out, the applicator 38 introduces a controlled spray 46 onto the aluminum foil sheet 36, the controlled spray 46 originating from the heat of the plasma field 42 as controlled spray 46 is combined with the contents of the powder feeder 40. The spray 46 exits the applicator 38 at the distal end 44 to apply the ceramic material onto the aluminum foil sheet 36 (i.e., the substrate 32).

The applicator 38 controls the spray 46 in a manner where the spray 46 is initially applied in a thick layer onto the aluminum foil sheet 36, creating the first ceramic layer 28 of the thermal barrier 26. The applicator 38 controls the spray 46 in a manner where the spray 46 is applied to the first ceramic layer 28 in a thinner layer compared to the first ceramic layer 28. The thinner layer is applied onto the first ceramic layer 28 to define the second ceramic layer 30. By controlling the spray 46 of the applicator 38, the first ceramic layer 28 has a greater or higher density and is less porous, or has a lower porosity, than the second ceramic layer 30. The application of the ceramic layers 28, 30 on the aluminum foil sheet 36 defines the thermal barrier 26 for the brake rotor 12.

Once the thermal barrier 26 is defined, the aluminum foil sheet 36 is cut using a cutter 48 to match the shape of the braking surface 24. Cutting the aluminum foil sheet 36 completes the process of creating the substrate 32 of the brake rotor 12, in which the thermal barrier 26 is disposed on the substrate 32 (FIG. 7). The brake rotor 12 includes a first substrate 32a and a second substrate 32b, the first substrate 32a serving as the application vessel for the first thermal barrier 26a configured to interface with the first braking surface 24a and the second substrate 32b serving as the application vessel for the second thermal barrier 26b configured to interface with the second braking surface 24b.

The first substrate 32a, affixed to the first thermal barrier 26a, and the second substrate 32b, affixed to the second thermal barrier 26b, are positioned in a brake rotor mold 50 that will serve as the mold 50 in which the body 16 of the brake rotor 12 is created. The first substrate 32a is positioned against a bottom surface 52 of the mold 50, while the second substrate 32b is positioned against a top surface 54 of the mold 50. Additionally or alternatively, the first substrate 32a may be positioned against the top surface 54, and the second substrate 32b may be positioned against the bottom surface 52. The first thermal barrier 26a and the second thermal barrier 26b define a cavity 56 within the mold 50, with the second ceramic layer 30 of the first thermal barrier 26a facing the second ceramic layer 30 of the second thermal barrier 26b on opposing sides of the mold 50.

Once each of the first substrate 32a, the first thermal barrier 26a, the second substrate 32b, and the second thermal barrier 26b, are positioned in the mold 50, the body 16 of the brake rotor 12, in liquid form, is deposited into the cavity 56 of the mold 50. The body 16 is in a first state when deposited into the cavity 56, which is defined by the body 16 being in liquid form. The liquid body 16 is disposed within the second ceramic layer 30 of both the first thermal barrier 26a and the second thermal barrier 26b. For example, the liquid body 16 may be integrally formed with the second ceramic layer 30 of each of the first thermal barrier 26a and the second thermal barrier 26b as the liquid body 16 is deposited into the mold 50.

The integration of the body 16 into the second ceramic layer 30 is accommodated by the porosity and the density of the second ceramic layer 30, allowing the liquid aluminum alloy material to seep into the pores of the second ceramic layer 30. As mentioned above, the second ceramic layer 30 has a higher or greater porosity and lower or lesser density as compared to the first ceramic layer 28. For example, the first ceramic layer 28 has a first porosity that is less than a second porosity of the second ceramic layer 30 and a first density that is greater or higher than a second density of the second ceramic layer 30. Thus, the liquid aluminum alloy material is restricted from becoming disposed within the first ceramic layer 28, as a result of the high density and low porosity of the first ceramic layer 28. By allowing the body 16 to become disposed within the second ceramic layer 30, the first thermal barrier 26a and the second thermal barrier 26b are integrated into the body 16.

The casting process that occurs with the body 16 of the brake rotor 12 is of the cast-in-place variety. The cast-in-place casting process may include, but is not limited to, high-pressure die casting, sand casting, squeeze casting, low-pressure casting, or any practicable cast-in-place method. Once the cavity 56 is substantially filled with the body 16, a curing process is executed. The body 16 may transition from a liquid form to a solid form during the casting process, such that the body 16 transitions from a first state (i.e., a liquid state) to a second state (i.e., a solid or semi-solid state). As the body 16 transitions from a liquid to a solid, the body 16 becomes integrally formed with the first thermal barrier 26a and the second thermal barrier 26b. Once the body 16 is fully solidified, the brake rotor 12 is fully manufactured, and the body 16, the first thermal barrier 26a, the first substrate 32a, the second thermal barrier 26b, and the second substrate 32b, are removed from the mold 50.

Once the brake rotor 12 is removed from the mold 50, the first substrate 32a and the second substrate 32b are removed at some point before the brake rotor 12 is incorporated with the vehicle 10. The substrate 32 is removed prior to incorporation of the brake rotor 12 with the vehicle 10. Thus, the substrate 32 is intended to be a sacrificial application vessel for the thermal barrier 26 during the formation of the brake rotor 12. Once the substrate 32 is removed, the first ceramic layer 28 of both the first thermal barrier 26a and the second thermal barrier 26b is exposed. The first ceramic layer 28 of the thermal barrier 26 makes direct contact with brake pads 12 installed in the caliper of the vehicle 10 during operation of the brake rotor 12. In other words, when the brake rotor 12 is installed at the vehicle 10, and the vehicle 10 performs a braking action, the brake pads in the caliper press against the first ceramic layer 28 of both the first thermal barrier 26a and the second thermal barrier 26b, causing the vehicle 10 to brake. The thermal barrier 26 acts to shield the body 16 of the brake rotor 12 from excessive heat generated during the braking process.

Manufacturing the thermal barrier 26 separately from the manufacturing of the body 16 of the brake rotor 12 provides significant production efficiency and flexibility. The thermal barrier 26 may be manufactured separately and apart from the body 16 at any point in time before the creation of the body 16. Furthermore, the curing process that occurs when the body 16 transitions from a liquid to a solid allows the body 16 to become integrally formed with the thermal barrier 26. The thermal barrier 26 also slows wear that may be experienced by the brake rotor 12 during an extended period of use, increasing the longevity of the brake rotor 12. Further, the thermal barrier 26 allows the excessive heat generated during braking at the vehicle 10 to be shielded from the body 16 of the brake rotor 12, which allows the aluminum alloy material to withstand the high temperature braking conditions experienced at the vehicle 10. Because the thermal barrier 26 provides for use of an aluminum alloy material for the body 16, the entire brake rotor 12 may weigh close to approximately seven (7) pounds, which contributes minimal weight to the overall mass of the vehicle 10.

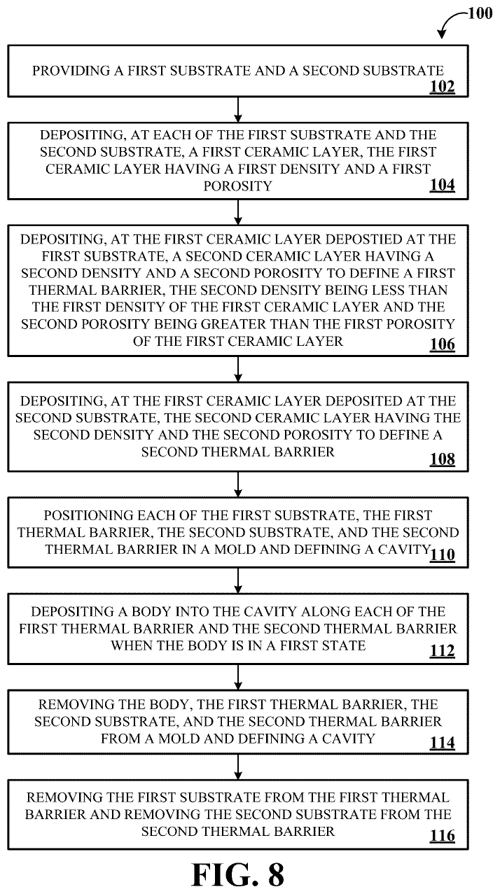

Referring again to FIGS. 1-8, a method 100 of manufacturing the brake rotor 12 includes providing, at 102, the first substrate 32a and the second substrate 32b. At 104, the first ceramic layer 28 is deposited on each of the first substrate 32a and the second substrate 32b, the first ceramic layer 28 having a first density and a first porosity. After the first ceramic layer 28 is deposited, the second ceramic layer 30 is deposited, at 106, on the first ceramic layer 28 at the first substrate 32a. The second ceramic layer 30 has a second density that is less than the first density of the first ceramic layer 28, and the second ceramic layer 30 also has a second porosity that is greater than the first porosity of the first ceramic layer 28. The first ceramic layer 28 and the second ceramic layer 30 at the first substrate 32a define the first thermal barrier 26a.

At 108, the second ceramic layer 30 is deposited on the first ceramic layer 28 at the second substrate 32b to define the second thermal barrier 26b. The first substrate 32a, the first thermal barrier 26a, the second substrate 32b, and the second thermal barrier 26b are positioned in the mold 50, at 110. The cavity 56 is defined by the first thermal barrier 26a and the second thermal barrier 26b, both of which face one another and are positioned on opposing sides of the mold 50. At 112, when the body 16 of the brake rotor 12 is in the first state defined by the body 16 being liquid in form, the body 16 is deposited in the cavity 56 along each of the first thermal barrier 26a and the second thermal barrier 26b. When the body 16 is in the second state, defined by the body 16 being solid in form, at 114, the body 16, the first thermal barrier 26a, the first substrate 32a, the second thermal barrier 26b, and the second substrate 32b are removed from the mold 50. At 116, the first substrate 32a is removed from the first thermal barrier 26a, and the second substrate 32b is removed from the second thermal barrier 26b.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A brake rotor comprising:
a body including at least one braking surface and a plurality of venting channels;
at least one thermal barrier disposed on the at least one braking surface, the at least one thermal barrier including:
a first ceramic layer having a first density and a first porosity; and
a second ceramic layer having a second density and a second porosity, the second density being less than the first density of the first ceramic layer and the second porosity being greater than the first porosity of the first ceramic layer, the second ceramic layer selectively engaged with the at least one braking surface of the body; and
a substrate selectively coupled to first ceramic layer of the at least one thermal barrier in a first state of the body, the brake rotor being free of the substrate in a second state of the body.

2. The brake rotor of claim 1, wherein the body includes an alloy including at least one of an aluminum-copper alloy and an aluminum-cerium alloy.

3. The brake rotor of claim 1, wherein the first ceramic layer and the second ceramic layer each include a ceramic material.

4. The brake rotor of claim 3, wherein the ceramic material includes at least one of magnesium zirconate and yttrium stabilized zirconia.

5. The brake rotor of claim 1, wherein the body is liquid in the first state and is at least partially disposed within the second ceramic layer of the at least one thermal barrier.

6. The brake rotor of claim 1, wherein the body is solid in the second state and the at least one braking surface is integrally formed with the second ceramic layer of the at least one thermal barrier.

7. The brake rotor of claim 1, wherein the substrate includes a metallic foil material.

8. The brake rotor of claim 1, wherein the first ceramic layer of the thermal barrier has a thickness between 100 and 500 microns, and wherein the second ceramic layer of the thermal barrier has a thickness between 100 and 500 microns.

9. A vehicle including the brake rotor of claim 1.

10. A method for manufacturing a brake rotor, the method comprising:
providing a first substrate and a second substrate;
depositing, at each of the first substrate and the second substrate, a first ceramic layer, the first ceramic layer having a first density and a first porosity;
depositing, at the first ceramic layer deposited at the first substrate, a second ceramic layer having a second density and a second porosity to define a first thermal barrier, the second density being less than the first density of the first ceramic layer and the second porosity being greater than the first porosity;
depositing, at the first ceramic layer deposited at the second substrate, the second ceramic layer having the second density and the second porosity to define a second thermal barrier;
positioning each of the first substrate, the first thermal barrier, the second substrate, and the second thermal barrier in a mold and defining a cavity;
depositing a body into the cavity along each of the first thermal barrier and the second thermal barrier when the body is in a first state;
removing the body, the first thermal barrier, the first substrate, the second thermal barrier, and the second substrate from the mold when the body is in a second state; and
removing the first substrate from the first thermal barrier and removing the second substrate from the second thermal barrier.

11. The method of claim 10, wherein the body is liquid in the first state and is at least partially disposed within the first thermal barrier and the second thermal barrier once deposited into the cavity, and the body is solid in the second state and is integrally formed with the first thermal barrier and the second thermal barrier.

12. The method of claim 10, wherein the body includes an alloy including at least one of an aluminum-copper alloy and an aluminum-cerium alloy.

13. The method of claim 10, wherein the first ceramic layer and the second ceramic layer each include a ceramic material, the ceramic material including at least one of magnesium zirconate and yttrium stabilized zirconia.

14. The method of claim 10, wherein a curing process allows the body to transition from the first state to the second state.

15. The method of claim 10, wherein the first ceramic layer of the first thermal barrier and second thermal barrier has a thickness between 100 and 500 microns, and wherein the second ceramic layer of the first thermal barrier and the second thermal barrier has a thickness between 100 and 500 microns.

16. A vehicle comprising:
a brake rotor including:
a body including at least one braking surface and a plurality of venting channels,
at least one thermal barrier disposed on the at least one braking surface, the at least one thermal barrier including:
a first ceramic layer having a first density and a first porosity, and
a second ceramic layer having a second density and a second porosity, the second density being less than the first density of the first ceramic layer and the second porosity being greater than the first porosity of the first ceramic layer, the second ceramic layer selectively engaged with the at least one braking surface of the body, and
a substrate selectively coupled to first ceramic layer of the at least one thermal barrier in a first state of the body, the brake rotor being free of the substrate in a second state of the body.

17. The vehicle of claim 16, wherein the body includes an alloy including at least one of an aluminum-copper alloy and an aluminum-cerium alloy.

18. The vehicle of claim 16, wherein the first ceramic layer and the second ceramic layer each include a ceramic material, the ceramic material including at least one of magnesium zirconate and yttrium stabilized zirconia.

19. The vehicle of claim 16, wherein the body is liquid in the first state and is at least partially disposed within the second ceramic layer of the at least one thermal barrier, and the body is solid in the second state and the at least one braking surface is integrally formed with the second ceramic layer of the at least one thermal barrier.

20. The vehicle of claim 16, wherein the first ceramic layer of the at least one thermal barrier has a thickness between 100 and 500 microns, and wherein the second ceramic layer of the at least one thermal barrier has a thickness between 100 and 500 microns.
